(19) United States
(12) Patent Application Publication
(10) Pub. No.: US 2023/0308417 A1
(43) Pub. Date: Sep. 28, 2023

(54) SYSTEMS AND METHODS FOR IMPLEMENTING SECURITY PROTOCOLS IN A BUILDING MANAGEMENT SYSTEM

(71) Applicant: Johnson Controls Tyco IP Holdings LLP, Milwaukee, WI (US)

(72) Inventors: Nathan Zimmerman, Wauwatosa, WI (US); Joshua Edler, Oak Creek, WI (US); Jacob R. Sheahan, Whitelaw, WI (US)

(21) Appl. No.: 17/704,609

(22) Filed: Mar. 25, 2022

(51) Int. Cl. H04L 9/40

(52) U.S. Cl. CPC H04L 63/0263; H04L 63/20

(57) ABSTRACT

A building management system network includes a Master-Slave/Token Passing (MS/TP) communication bus. The network further includes a number of Building Automation Control network (BACnet) devices, including a first BACnet device and a second BACnet device, coupled to the MS/TP communication bus. The network further includes a number of bridge devices, including a first bridge device, connected to the MS/TP communication bus. The first bridge device is located on the MS/TP communication bus between the first BACnet device and the second BACnet device. The first bridge device includes a processing circuit and a memory. The processing circuit is configured to receive a first MS/TP packet from the first BACnet device and selectively forward the first MS/TP packet to the second BACnet device based on a first security configuration. The first security configuration is stored in the memory.

### BACKGROUND

The present disclosure relates generally to building networks for monitoring and controlling building equipment in or around a building. More specifically, the present disclosure relates to systems and methods for reducing a security risk of undesired communications from one device to another in a building network.

A building management system (BMS) is, in general, a system of devices configured to control, monitor, and manage equipment in or around a building or building area. A BMS can include a heating, ventilation, or air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may communicate via a Building Automation Control network (BACnet) Master-Slave/Token Passing (MS/TP) protocol. A BMS may include VERASYS® building controllers or other devices sold by Johnson Controls, Inc., as well as building devices, controllers, and components from other sources.

### SUMMARY

One implementation of the present disclosure relates to a building management system network configured to reduce security risk. The network includes a Master-Slave/Token Passing (MS/TP) communication bus. The network further includes a number of Building Automation Control network (BACnet) devices coupled to the MS/TP communication bus. The number of BACnet devices includes a first BACnet device and a second BACnet device connected to the first MS/TP communication bus and a second BACnet device connected to the MS/TP communication bus. The network further includes a number of bridge devices connected to the MS/TP communication bus. The number of bridge devices includes a first bridge device. The first bridge device is located on the MS/TP communication bus between the first BACnet device and the second BACnet device. The first bridge device includes a processing circuit and a memory. The processing circuit is configured to receive a first MS/TP packet from the first BACnet device and selectively forward the first MS/TP packet to the second BACnet device based on a first security configuration. The first security configuration is stored in the memory.

Another implementation of the present disclosure relates to a method for reducing security risk on a building management system communication network. The network includes an MS/TP communication bus and a number of BACnet devices connected to the MS/TP communication bus. The number of BACnet devices includes a first BACnet device and a second BACnet device. The method includes providing a bridge device connected to the MS/TP communication bus and located between the first BACnet device and the second BACnet device. The bridge device includes a processing circuit. The method further includes receiving, by the processing circuit, a first MS/TP packet from the first BACnet device. The method further includes identifying, by the processing circuit, at least one of MS/TP address information, Network Protocol Data Unit (NPDU) information, and Application Protocol Data Unit (APDU) information, from the first MS/TP packet. The method further includes configuring, by the processing circuit, a first security configuration. The first security configuration is based on the at least one of the MS/TP address information, NPDU information, or APDU information. The method further includes selectively forwarding, by the processing circuit, the first MS/TP packet to the second BACnet device, based on the first security configuration.

Another implementation of the present disclosure relates to a bridge device for reducing security risk on a building management system communication network. The bridge device includes a first interface connected to a first MS/TP network segment of an MS/TP communication bus. The bridge device further includes a second interface connected to a second network segment of the MS/TP communication bus. The bridge device further includes a communications processor. The communications processor is configured to receive an MS/TP packet from the first MS/TP network segment via the first interface. The communications processor is further configured to selectively forward the MS/TP packet to the second MS/TP network segment via the second interface based on a security configuration.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view schematic drawing of a building equipped with a HVAC system, according to some embodiments.

FIG. 2 is a schematic drawing of a waterside system which can be used as part of the HVAC system of FIG. 1, according to some embodiments.

FIG. 3 is a block diagram of an airside system which can be used as part of the HVAC system of FIG. 1, according to some embodiments.

FIG. 4A is a block diagram of a BMS which can be used in the building of FIG. 1, according to some embodiments.

FIG. 4B is a block diagram of a BMS which can be used in the building of FIG. 1, according to some embodiments.

FIG. 4C is a block diagram of a BMS which can be used in the building of FIG. 1, according to some embodiments.

FIG. 5 is a block diagram of a security bridge device for use in a network in the building of FIG. 1, according to an exemplary embodiment.

FIG. 6A is a block diagram of a wireless security bridge device for use in a network in the building of FIG. 1, according to an exemplary embodiment.

FIG. 6B is a block diagram of a network in the building of FIG. 1, according to an exemplary embodiment.

FIG. 7A is a block diagram of a network in the building of FIG. 1, according to an exemplary embodiment.

FIG. 7B is a block diagram of the network of FIG. 7A with an additional BACnet device, according to an exemplary embodiment.

FIG. 7C is a block diagram of the network of FIG. 7B with an attacker device, according to an exemplary embodiment.

FIG. 8 is a block diagram of a network in the building of FIG. 1 with security bridge devices provided on a per-BACnet-device basis, according to an exemplary embodiment.

FIG. 9 is a flow diagram showing the operation of the security bridge device of FIG. 5, according to an exemplary embodiment.

FIG. 10A is a block diagram showing the memory of the security bridge device of FIG. 5, according to an exemplary embodiment.

FIG. 10B is a block diagram showing the memory of the security bridge device of FIG. 5, according to an exemplary embodiment.

FIG. 11 is block diagram of an MS/TP packet for use in a network in the building of FIG. 1, according to an exemplary embodiment.

### DETAILED DESCRIPTION

### Overview

Referring generally to the FIGURES, a security bridge device is used in Master-Slave Token Passing (MS/TP) networks to reduce security risk of unwanted communications from one device to another according to various embodiments. In many buildings, various building equipment components are connected together via one or more MS/TP communication buses. In some embodiments, these building equipment components communicate via a Building Automation Communication network (BACnet) protocol. In many cases, MS/TP buses and BACnet networks in general have little to no security. This is because an MS/TP device can write to any other MS/TP device even if it should not have permission to do so. Accordingly, a hostile device (e.g. a third-party device, malfunctioning device, etc.) may take over a portion of an MS/TP bus by connecting to the MS/TP bus and injecting unwanted communications (e.g. MS/TP packets, BACnet commands, read commands, write commands, etc.). In such cases, one or more building equipment components (e.g. field devices, edge devices, peripheral components, BACnet devices, any device within routing scope, etc.) may be at risk of manipulation by the hostile device. In some embodiments, a security bridge device is provided that addresses challenges associated with hostile device communications.

Advantageously, the bridge device may provide a network firewall and/or provide a level of security against packet injections on a portion of a MS/TP bus should a third party gain physical access to a portion of the MS/TP bus. The bridge device may be used in existing and legacy networks and retrofitted onto existing MS/TP buses.

### Building Management System

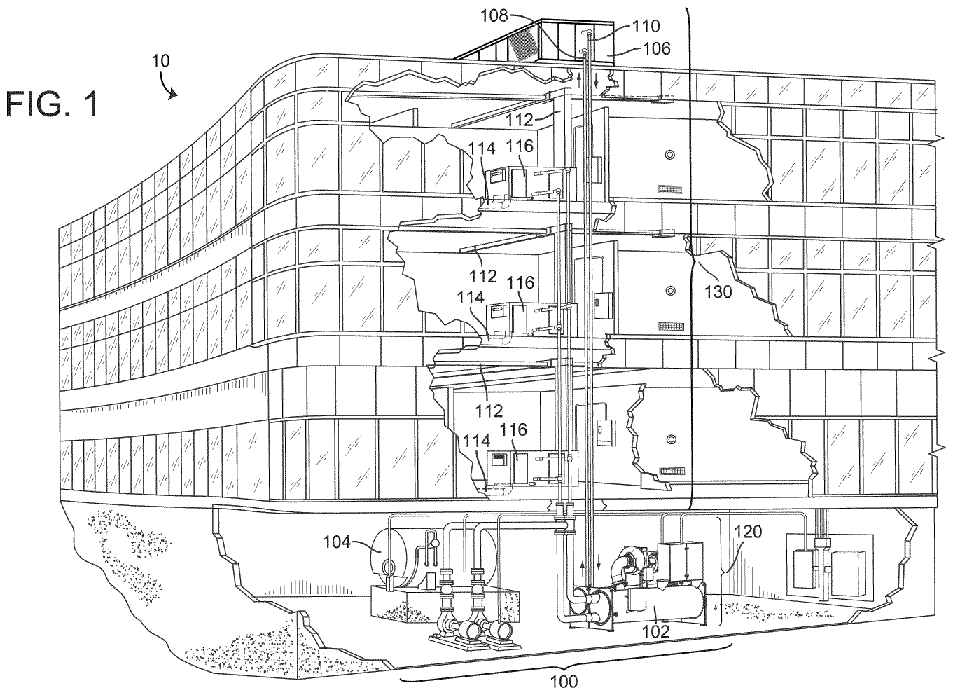

Referring now to FIG. 1, a perspective view of a building 10 is shown. Building 10 is served by a building management system (BMS). A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

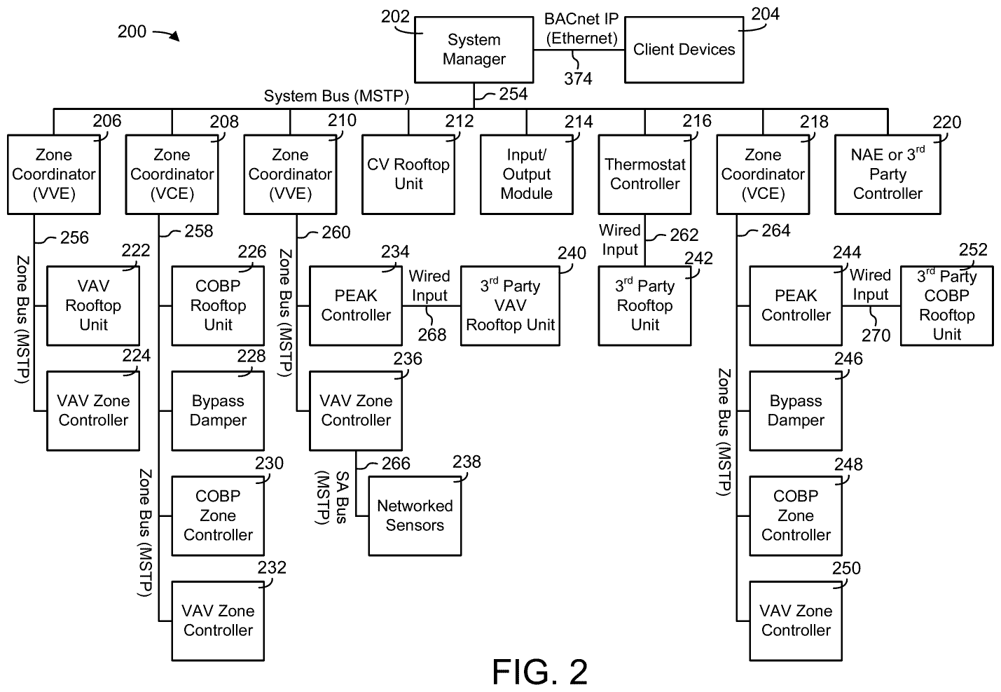

The BMS that serves building 10 includes an HVAC system 100. HVAC system 100 may include a number of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. In some embodiments, waterside system 120 is replaced with a central energy plant such as central plant 200, described with reference to FIG. 2.

In some embodiments, building 10 acts as a building or campus (e.g., several buildings) capable of housing some or all components of HVAC system 100. While the systems and methods described herein are primarily focused on operations within a typical building (e.g., building 10), they can easily be applied to various other enclosures or spaces (e.g., cars, airplanes, recreational vehicles, etc.). For example, pollutant management system 592 as described below may be implemented in a recreational vehicle for filtering one or more fluids within the vehicle.

Still referring to FIG. 1, HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via air supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Still referring to FIG. 2, BMS 200 is shown to include a system manager 202; several zone coordinators 206, 208, 210 and 218; and several zone controllers 224, 230, 232, 236, 248, and 250. System manager 202 can communicate with client devices 204 (e.g., user devices, desktop computers, laptop computers, mobile devices, etc.) via a data communications link 374 (e.g., BACnet/IP, Ethernet, wired or wireless communications, etc.). System manager 202 can provide a user interface to client devices 204 via data communications link 374. The user interface may allow users to monitor and/or control BMS 200 via client devices 204.

In some embodiments, system manager 202 is connected with zone coordinators 206-210 and 218 via a system bus 254. System bus 254 can include any of a variety of communications hardware (e.g., wire, optical fiber, terminals, etc.) configured to facilitate communications between system manager and other devices connected to system bus 254. Throughout this disclosure, the devices connected to system bus 254 are referred to as system bus devices. System manager 202 can be configured to communicate with zone coordinators 206-210 and 218 via system bus 254 using a master-slave token passing (MSTP) protocol or any other communications protocol. System bus 254 can also connect system manager 202 with other devices such as a constant volume (CV) rooftop unit (RTU) 212, an input/output module (IOM) 214, a thermostat controller 216 (e.g., a TEC2000 series thermostat controller), and a network automation engine (NAE) or third-party controller 220. RTU 212 can be configured to communicate directly with system manager 202 and can be connected directly to system bus 254. Other RTUs can communicate with system manager 202 via an intermediate device. For example, a wired input 262 can connect a third-party RTU 242 to thermostat controller 216, which connects to system bus 254.

System manager 202 can provide a user interface for any device containing an equipment model. Devices such as zone coordinators 206-210 and 218 and thermostat controller 216 can provide their equipment models to system manager 202 via system bus 254. In some embodiments, system manager 202 automatically creates equipment models for connected devices that do not contain an equipment model (e.g., IOM 214, third party controller 220, etc.). For example, system manager 202 can create an equipment model for any device that responds to a device tree request. The equipment models created by system manager 202 can be stored within system manager 202. System manager 202 can then provide a user interface for devices that do not contain their own equipment models using the equipment models created by system manager 202. In some embodiments, system manager 202 stores a view definition for each type of equipment connected via system bus 254 and uses the stored view definition to generate a user interface for the equipment.

Each zone coordinator 206-210 and 218 can be connected with one or more of zone controllers 224, 230-232, 236, and 248-250 via zone buses 256, 258, 260, and 264. Zone busses 256, 258, 260, and 264 can include any of a variety of communications hardware (e.g., wire, optical fiber, terminals, etc.) configured to facilitate communications between a zone coordinator and other devices connected to the corresponding zone bus. Throughout this disclosure, the devices connected to zone busses 256, 258, 260, and 264 are referred to as zone bus devices. Zone coordinators 206-210 and 218 can communicate with zone controllers 224, 230-232, 236, and 248-250 via zone busses 256-260 and 264 using a MSTP protocol or any other communications protocol. Zone busses 256-260 and 264 can also connect zone coordinators 206-210 and 218 with other types of devices such as variable air volume (VAV) RTUs 222 and 240, changeover bypass (COBP) RTUs 226 and 252, bypass dampers 228 and 246, and PEAK controllers 234 and 244.

Zone coordinators 206-210 and 218 can be configured to monitor and command various zoning systems. In some embodiments, each zone coordinator 206-210 and 218 monitors and commands a separate zoning system and is connected to the zoning system via a separate zone bus. For example, zone coordinator 206 can be connected to VAV RTU 222 and zone controller 224 via zone bus 256. Zone coordinator 208 can be connected to COBP RTU 226, bypass damper 228, COBP zone controller 230, and VAV zone controller 232 via zone bus 258. Zone coordinator 210 can be connected to PEAK controller 234 and VAV zone controller 236 via zone bus 260. Zone coordinator 218 can be connected to PEAK controller 244, bypass damper 246, COBP zone controller 248, and VAV zone controller 250 via zone bus 264.

A single model of zone coordinator 206-210 and 218 can be configured to handle multiple different types of zoning systems (e.g., a VAV zoning system, a COBP zoning system, etc.). Each zoning system can include a RTU, one or more zone controllers, and/or a bypass damper. For example, zone coordinators 206 and 210 are shown as Verasys VAV engines (VVEs) connected to VAV RTUs 222 and 240, respectively. Zone coordinator 206 is connected directly to VAV RTU 222 via zone bus 256, whereas zone coordinator 210 is connected to a third-party VAV RTU 240 via a wired input 268 provided to PEAK controller 234. Zone coordinators 208 and 218 are shown as Verasys COBP engines (VCEs) connected to COBP RTUs 226 and 252, respectively. Zone coordinator 208 is connected directly to COBP RTU 226 via zone bus 258, whereas zone coordinator 218 is connected to a third-party COBP RTU 252 via a wired input 270 provided to PEAK controller 244.

Zone controllers 224, 230-232, 236, and 248-250 can communicate with individual BMS devices (e.g., sensors, actuators, etc.) via sensor/actuator (SA) busses. For example, VAV zone controller 236 is shown connected to networked sensors 238 via SA bus 266. Networked sensors 238 can include, for example, temperature sensors, humidity sensors, pressure sensors, lighting sensors, security sensors, or any other type of device configured to measure and/or provide an input to zone controller 236. Zone controller 236 can communicate with networked sensors 238 using a MSTP protocol or any other communications protocol. Although only one SA bus 266 is shown in FIG. 2, it should be understood that each zone controller 224, 230-232, 236, and 248-250 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 224, 230-232, 236, and 248-250 can be configured to monitor and control a different building zone. Zone controllers 224, 230-232, 236, and 248-250 can use the inputs and outputs provided via their SA busses to monitor and control various building zones. For example, a zone controller 236 can use a temperature input received from networked sensors 238 via SA bus 266 (e.g., a measured temperature of a building zone) as feedback in a temperature control algorithm. Zone controllers 224, 230-232, 236, and 248-250 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

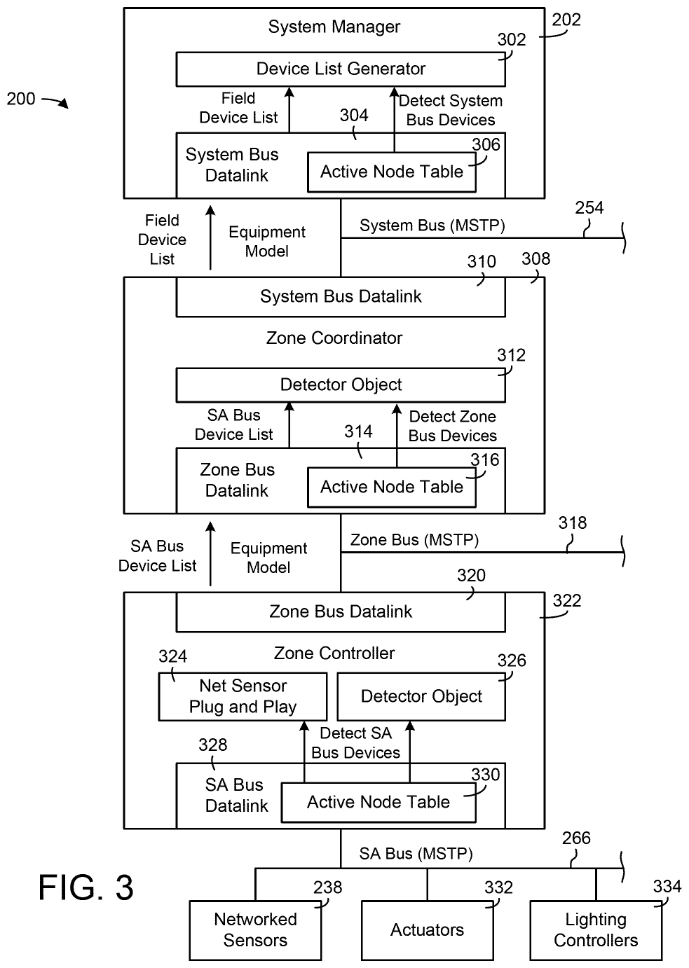

Referring now to FIG. 3, a block diagram illustrating a portion of BMS 200 in greater detail is shown, according to an exemplary embodiment. BMS 200 is shown to include system manager 202, a zone coordinator 308, and a zone controller 322. Zone coordinator 308 can be any of zone coordinators 206-210 or 218. Zone controller 322 can be any of zone controllers 224, 230, 232, 236, 248, or 250. Zone coordinator 308 can be connected with system manager via system bus 254. For example, system bus 254 is shown connecting a first system bus datalink 304 within system manager 202 with a second system bus datalink 310 within zone coordinator 308. Zone coordinator 308 can connected with zone controller 322 via a zone bus 318. For example, zone bus 318 is shown connecting a first zone bus datalink 314 within zone coordinator 308 with a second zone bus datalink 320 within zone controller 322. Zone bus 318 can be any of zone busses 256-260 or 264. Zone controller 322 is connected with networked sensors 238 and actuators 332 via a SA bus 266.

BMS 200 can automatically discover new equipment connected to any of system bus 254, zone bus 318, and SA bus 266. Advantageously, the equipment discovery can occur automatically (e.g., without user action) without requiring the equipment to be placed in discovery mode and without sending a discovery command to the equipment. In some embodiments, the automatic equipment discovery is based on active node tables for system bus 254, zone bus 318, and SA bus 266. Each active node table can provide status information for the devices communicating on a particular bus. For example, the active node table 306 for system bus 254 can indicate which MSTP devices are participating in the token ring used to exchange information via system bus 254. Active node table 306 can identify the devices communicating on system bus 254 by MAC address or other device identifier. Devices that do not participate in the token ring (e.g., MSTP slave devices) can be automatically discovered using a net sensor plug and play (described in greater detail below).

The active node table for each communication bus can be stored within one or more devices connected to the bus. For example, active node table 306 can be stored within system manager 202. In some embodiments, active node table 306 is part of a system bus datalink 304 (e.g., a MSTP datalink) used by system manager 202 to communicate via system bus 254. System manager 202 can subscribe to changes in value of active node table 306 and can receive a notification (e.g., from system bus datalink 304) when a change in active node table 306. In response to a notification that a change in active node table 306 has occurred, system manager 202 can read active node table 306 to detect and identify the devices connected to system bus 254.

In some embodiments, a device list generator 302 within system manager 202 generates a list of the devices connected to system bus 254 (i.e., a device list) based on active node table 306 and stores the device list within system manager 202. The device list generated by system manager 202 can include information about each device connected to system bus 254 (e.g., device type, device model, device ID, MAC address, device attributes, etc.). When a new device is detected on system bus 254, system manager 202 can automatically retrieve the equipment model from the device if the device stores its own equipment model. If the device does not store its own equipment model, system manager 202 can retrieve a list of point values provided by the device. System manager 202 can then use the equipment model and/or list of point values to present information about the connected system bus devices to a user.

The active node tables for each zone bus can be stored within the zone coordinator connected to the zone bus. For example, the active node table 316 for zone bus 318 can be stored within zone coordinator 308. In some embodiments, active node table 316 is part of a zone bus datalink 314 (e.g., a MSTP datalink) used by the zone coordinator 308 to communicate via zone bus 318. Zone coordinator 308 can subscribe to changes in value of active node table 316 and can receive a notification (e.g., from zone bus datalink 314) when a change in active node table 316 occurs. In response to a notification that a change to active node table 316 has occurred, zone coordinator 308 can read active node table 316 to identify the devices connected to zone bus 318.

In some embodiments, a detector object 312 of zone coordinator 308 generates a list of the devices communicating on zone bus 318 (i.e., a device list) based on active node table 316 and stores the device list within zone coordinator 308. Each zone coordinator in BMS 200 can generate a list of devices on the connected zone bus. The device list generated by each zone coordinator 308 can include information about each device connected to zone bus 318 (e.g., device type, device model, device ID, MAC address, device attributes, etc.). When a new device is detected on zone bus 318, the connected zone coordinator 308 can automatically retrieve the equipment model from the device if the device stores its own equipment model. If the device does not store its own equipment model, the connected zone coordinator 308 can retrieve a list of point values provided by the device.

Zone coordinator 308 can incorporate the new zone bus device into the zoning logic and can inform system manager 202 that a new zone bus device has been added. For example, zone coordinator 308 is shown providing a field device list to system manager 202. The field device list can include a list of devices connected to zone bus 318 and/or SA bus 266. System manager 202 can use the field device list and the list of system bus devices to generate a device tree including all of the devices in BMS 200. In some embodiments, zone coordinator 308 provides an equipment model for a connected zone bus device to system manager 202. System manager 202 can then use the equipment model and/or list of point values for the new zone bus device to present information about the new zone bus device to a user.

In some embodiments, the device list generated by each zone coordinator 308 indicates whether system manager 202 should communicate directly with the listed zone bus device (e.g., VAV RTU 222, VAV zone controller 224, etc.) or whether system manager 202 should communicate with the intermediate zone coordinator 308 on behalf of the zone bus device. In some embodiments, system manager 202 communicates directly with zone bus devices that provide their own equipment models, but communicates with the intermediate zone coordinator 308 for zone bus devices that do not provide their own equipment models. As discussed above, the equipment models for zone bus devices that do not provide their own equipment model can be generated by the connected zone coordinator 308 and stored within the zone coordinator 308. Accordingly, system manager 202 may communicate directly with the device that stores the equipment model for a connected zone bus device (i.e., the zone bus device itself or the connected zone coordinator 308).

The active node table 330 for SA bus 266 can be stored within zone controller 322. In some embodiments, active node table 330 is part of the SA bus datalink 328 (e.g., a MSTP datalink) used by zone controller 322 to communicate via SA bus 266. Zone controller 322 can subscribe to changes in value of the active node table 330 and can receive a notification (e.g., from SA bus datalink 328) when a change in active node table 330 occurs. In response to a notification that a change to active node table 330 has occurred, zone controller 322 can read active node table 330 to identify some or all of the devices connected to SA bus 266. In some embodiments, active node table 330 identifies only the SA bus devices participating in the token passing ring via SA bus 266 (e.g., MSTP master devices). Zone controller 322 can include an additional net sensor plug and play (NsPnP) 324 configured to detect SA bus devices that do not participate in the token passing ring (e.g., MSTP slave devices).

In some embodiments, NsPnP 324 is configured to actively search for devices connected to SA bus 266 (e.g., networked sensors 238, actuators 332, lighting controllers 334, etc.). For example, NsPnP 324 can send a “ping” to a preconfigured list of MSTP slave MAC addresses. For each SA bus device that is discovered (i.e. responds to the ping), NsPnP 324 can dynamically bring it online. NsPnP 324 can bring a device online by creating and storing an instance of a SA bus device object representing the discovered SA bus device. NsPnP 324 can automatically populate the SA bus device object with all child point objects needed to collect and store point data (e.g., sensor data) from the newly discovered SA bus device. In some embodiments, NsPnP 324 automatically maps the child point objects of the SA bus device object to attributes of the equipment model for zone controller 322. Accordingly, the data points provided by the SA bus devices can be exposed to zone coordinator 308 and other devices in BMS 200 as attributes of the equipment model for zone controller 322.

In some embodiments, a detector object 326 of zone controller 322 generates a list of the devices connected to SA bus 266 (i.e., a device list) based on active node table 330 and stores the device list within zone controller 322. NsPnP 324 can update the device list to include any SA bus devices discovered by NsPnP 324. The device list generated by zone controller 322 can include information about each device connected to SA bus 266 (e.g., device type, device model, device ID, MAC address, device attributes, etc.). When a new device is detected on SA bus 266, zone controller 322 can automatically retrieve the equipment model from the device if the device stores its own equipment model. If the device does not store its own equipment model, zone controller 322 can retrieve a list of point values provided by the device.

Zone controller 322 can incorporate the new SA bus device into the zone control logic and can inform zone coordinator 308 that a new SA bus device has been added. Zone coordinator 308 can then inform system manager 202 that a new SA bus device has been added. For example, zone controller 322 is shown providing a SA device list to zone coordinator 308. The SA device list can include a list of devices connected to SA bus 266. Zone coordinator 308 can use the SA device list and the detected zone bus devices to generate the field device list provided to system manager 202. In some embodiments, zone controller 322 provides an equipment model for a connected SA bus device to zone coordinator 308, which can be forwarded to system manager 202. System manager 202 can then use the equipment model and/or list of point values for the new SA bus device to present information about the new SA bus device to a user. In some embodiments, data points provided by the SA bus device are shown as attributes of the zone controller 322 to which the SA bus device is connected.

Additional features and advantages of BMS 200, system manager 202, zone coordinator 308, and zone controller 322 are described in detail in U.S. patent application Ser. No. 15/179,894 filed Jun. 10, 2016, the entire disclosure of which is incorporated by reference herein.

### Network Routing System

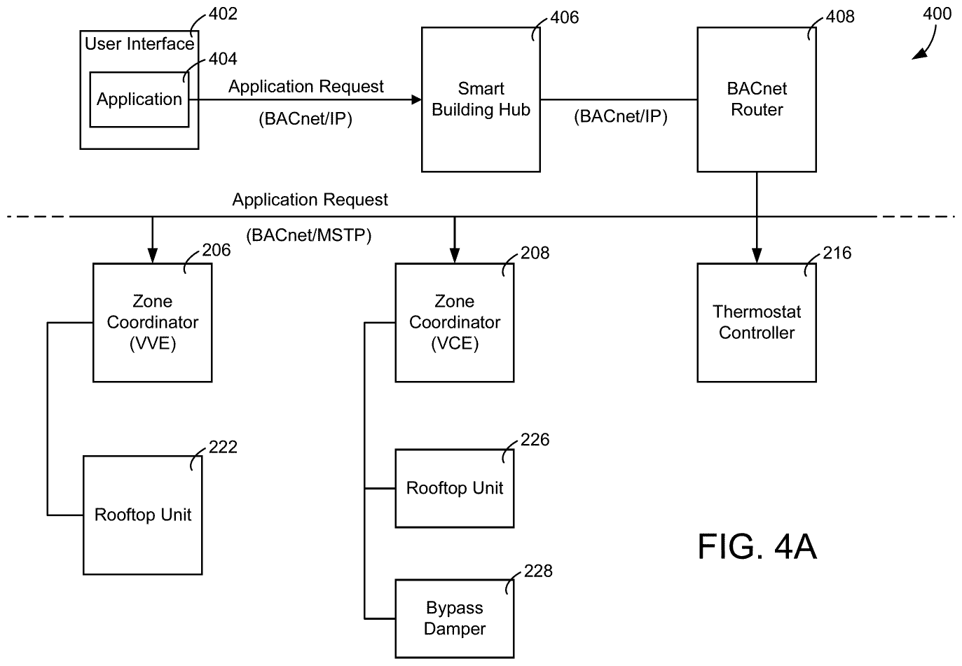

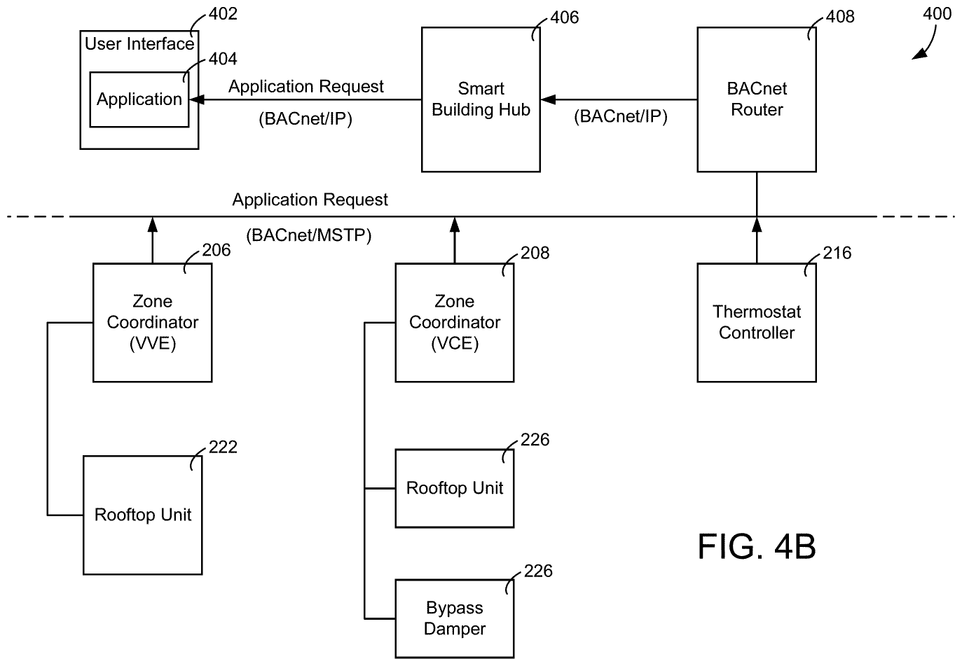

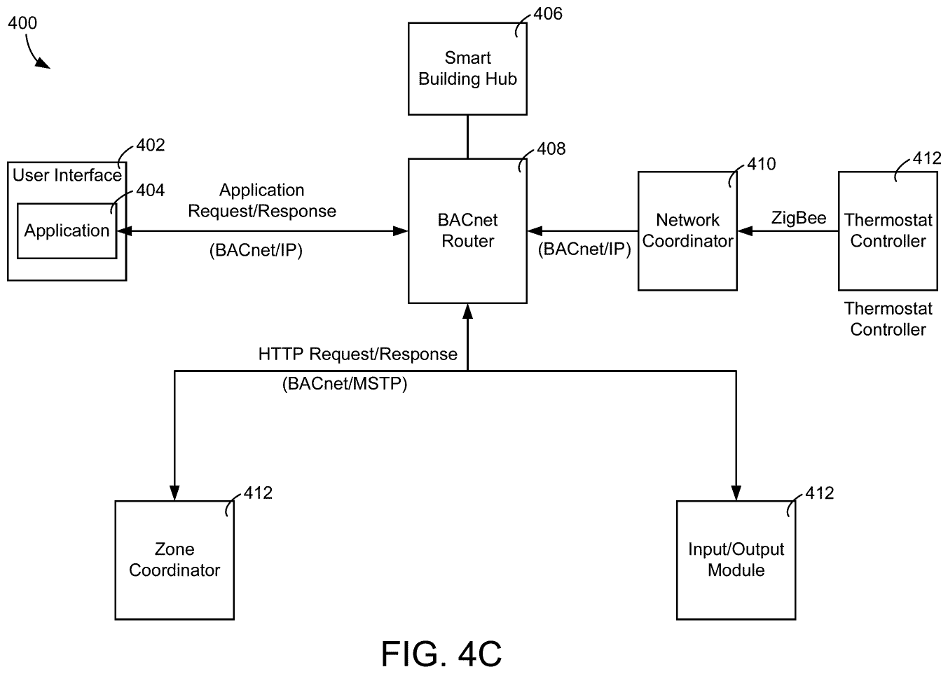

Referring to FIG. 4A, a system 400 for providing an application request to a routing device is shown, according to some embodiments. Referring to FIG. 4B, system 400 for responding to an application request is shown, according to some embodiments. FIG. 4B shows zone coordinator 206, zone coordinator 208, and thermostat controller 216 responding to an application request (e.g., the application request as shown in FIG. 4A) and providing device information to router 408 for routing to application 404. Referring now to FIGS. 4A-4B, a system 400 for providing and receiving application requests are shown, according to exemplary embodiments. System 400 may be incorporated partially or entirely into system 200 as shown in FIG. 2. In some embodiments, system 400 is a part of system 200. System 400 is shown to include user interface 402, smart building hub 406, and BACnet router 408.

User interface 402 may be any display capable of displaying information related to systems 200, 400, building 10, or any other system disclosed herein. User interface 402 may be provided on a laptop, smartphone, workstation, or other computing device. In some embodiments, HVAC client devices (e.g., devices for HVAC technicians within building 10) may display user interface 402. In some embodiments, user interface 402 may be configured to display the alarms, conditions, subsystems, and operational status of the BMS for building 10, such as Verasys as sold by Johnson Controls Inc. or Metasys as sold by Johnson Controls Inc. via application 404. In some embodiments, user interface 402 displays application 404 (e.g., phone application, phone app, etc.), which is provided as a software as a service (SaaS). For example, the processing and storage of application 404 for monitoring/controlling a building management system (e.g., Verasys) is performed at a data center located in a different area (e.g., different state, different country, etc.) than building 10. When a client device (e.g., a device hosting user interface 402) requests application 404, application 404 is provided to user interface 402 via a network (e.g., the Cloud, the Internet, etc.). In some embodiments, application 404 is any network software application that utilizes the Internet or other interconnected network infrastructure (e.g., the cloud, etc.) to perform various functionality (e.g., data transfer, etc.). Application 404 may include pure network applications and standalone network applications.

Smart building hub (SBH) 406 may be configured to act as a scalable control center for system 400 and/or system 200 that manages multiple building zones and building applications in real time. SBH 406 may incorporate some or all of the features of system manager 202 as shown in FIG. 2. In some embodiments, SBH 406 is a central controller configured to receive device information from zone coordinators (e.g., zone coordinator 206), controllers (e.g., thermostat controller 216), and various other devices on the network. SBH 406 may be connected via BACnet protocol under a master slave token passing (MS/TP) protocol such that SBH 406 acts as a “master” configured to request services from one or more slave devices. In other embodiments, SBH is connected to a different BACnet protocol, such as BACnet/IP or BACnet/Ethernet.

BACnet router 408 (i.e., “router 408”) may be configured to receive and forward data packets along a network. In some embodiments, router 408 routes data from a first network to a second network. As shown in FIG. 4A, router 408 is connected to a BACnet/IP network (via SBH 406) and is connected to a BACnet/MSTP network (via zone coordinators 206, 208 and thermostat controller 216). Router 408 may be configured to route data between various networks that operate under the Building Automation and Control networks (BACnet) protocol. In other embodiments, router 408 routes data between networks that operate under other building protocols, such as Modbus or LonWorks. Router 408 may be configured to optimize routing capabilities within system 400 that allow application requests to be completed using efficient methods (e.g., converting multiple application responses into a single response for application 404).

In some embodiments, SBH 406 and router 408 are not separate devices, and SBH 406 performs all of the routing functionality of router 408. In other embodiments, SBH 406 is not included in system 400, and router 408 receives application requests from application 404 and device information from controllers. In such an embodiment, device information from data objects stored on system controllers (e.g., zone coordinator 206, etc.) are provided to router 408, for forwarding to user interface 402.

Still referring to FIG. 4A, SBH 406 is configured to receive application requests from an application (e.g., application 404) on user interface 402 and request services from lower-level controllers (i.e., controllers that a below SBH 406 on the network), such as zone coordinator 206. For example, a user interacts with application 404 and clicks on a widget titled, “Power Consumption of Rooftop Units in the Building.” Application 404 sends this application request to SBH 406 and SBH 406 receives the application request and requests zone coordinator 206 to provide the power consumption for rooftop unit 222 and requests zone coordinator 208 to provide the power consumption for rooftop unit 226. Once received, SBH 406 may collect the multiple responses received and provide a single response to application 404.

In another example, a user interacts with application 404 and clicks on a widget titled, “Temperature of HVAC Equipment.” Application 404 sends this application request to SBH 406. SBH 406 receives the application request and requests the temperature information for various HVAC equipment (e.g., boilers, chillers, rooftop units, etc.). This may include receiving information from HVAC equipment not shown in FIG. 4A. In some embodiments, the data (e.g., temperature data in the above example) may be stored in zone coordinator 206 as part of a data object (e.g., data models, etc.). In such an embodiment, most or all information relating to rooftop unit 222 (e.g., the seasonal energy efficiency ratio (SEER) rating, sound level (dB), operation temperature, power consumption, current draw, etc.) is received and stored within zone coordinator 206. In other embodiments, the data or data models are provided to SBH 406.

Referring now to FIG. 4C, another method of providing responses to application requests within system 400 is shown, according to an exemplary embodiment. System 400 is shown to have router 408 routing the data between networks (e.g., BACnet/IP and BACnet/MSTP) without the data passing through SBH 0406. FIG. 4C shows various networks providing data to BACnet router 408, including BACnet/MSTP and ZigBee (i.e., IEEE 802.15.4) wireless communication. System 400 is shown to include network coordinator 410 and thermostat 412.

Network coordinator 410 may be configured to provide a network connection between two networks, wherein one network operates under one communications protocol and the other operates under a different communications protocol. For example, network coordinator 410, as shown in FIG. 4C, connects thermostat controller 412 (which communicates under Zigbee communications protocols) with BACnet/IP to router 408. Accordingly, system 400 is capable of networking data under the BACnet communications protocol, which includes data from a separate, non BACnet compatible network (e.g., Zigbee).

In a general embodiment, system 400 operates under a building automation protocol such as BACnet. To communicate between devices within a BAS under BACnet, devices may provide services to other devices. As disclosed herein, a service may be a means or interface between two devices to access and process information, request to perform an action, or inform the devices that some event has taken place. In some embodiments, some services that may be implemented include who-is, I-am, who-has, I-have, read-property, and write-property. Additionally, the services may be based, at least in part, on objects. Various advanced services may be implemented including ready property multiple, write property multiple, and subscribe COV property.

In some embodiments, a read property multiple is a single request to read multiple properties from a BACnet object instead of having to send multiple read property requests. For example, application 404 provides a request to router 408 that includes reading multiple properties (e.g., name, device type, power consumption, operating temperature) from a BACnet object (e.g., boiler, chiller, etc.). Router 408 receives the multiple properties from the BACnet object and provides a single response to application 404. In some embodiments, read property multiple includes reading multiple properties from multiple different BACnet objects (e.g., multiple boilers, chillers, RTU's, controllers, etc.).

In some embodiments, write property multiple is a single request to write multiple properties of a BACnet object instead of having to send multiple write property requests. For example, application 404 provides a request to router 408 that includes writing multiple properties of a BACnet object (e.g., operating thresholds, maximum current draw, device name, etc.). Write properly multiple may allow application 404 to provide a single write request for several properties of one or more BACnet objects. In some embodiments, write property multiple includes writing multiple properties from multiple different BACnet objects (e.g., multiple boilers, chillers, RTU's, controllers, etc.).

In some embodiments, subscribe COV property is an ability to sign up for notifications of changes of vale (COVs) of a property of a BACnet object instead of having to poll the value. For example, application 404 may provide a request to sign up for notifications of COV's of temperature values for thermostat controller 412. When the temperature changes over a predetermined threshold, router 408 may pull the temperature from the data object of thermostat controller 412 and provide the data to application 404 automatically.

### Security Bridge Device System

Some embodiments relate to a system for and method of providing a security bridge device system for a building, such as the building 10 (FIG. 1). The security bridge devices connect segments of a network communication bus such that Master-Slave/Token Passing (MS/TP) and/or Building Automation Control network (BACnet) devices are protected from the injection of communications provided to the bus by third-party and/or hostile devices. In some embodiments, each bridge device can forward messages received on one of its multiple communications interfaces (e.g., MS/TP interface, wired interfaced, etc.) to the appropriate destination via another one of its multiple communications interfaces, when applicable. In some embodiments, each bridge device forwards messages (e.g., BACnet messages, MS/TP packets, etc.) received from one or more BACnet devices to applicable local BACnet devices, when applicable. In some embodiments, each bridge device is locally configured (e.g., wired). For example, the communications interfaces may be wired communications interfaces. In other embodiments, each bridge device is wirelessly configured to communicate with other bridge devices on its network. For example, the communications interfaces may be radios. In other embodiments still, the bridge devices are a combination of local and wireless configurations.

In some embodiments, the bridge device is connected to an MS/TP communication bus. The bridge device may be inserted into the MS/TP communication bus by being connected to a first MS/TP network segment and a second MS/TP network segment (e.g., thus acting as a bridge between the first MS/TP network segment and the second MS/TP network segment). One or more BACnet devices may be connected to the MS/TP communication bus. For example, one or more BACnet devices may be connected to the first MS/TP network segment and one or more BACnet devices may be connected to the second MS/TP network segment. The various BACnet devices may send one or more MS/TP packets on the MS/TP communication bus and such that the MS/TP packets are required to cross the bridge device in order to reach the intended recipient of the communication(s). The bridge device may be required to receive the MS/TP packets and forward them to the intended recipient BACnet device in order for the MS/TP communications to be completed. Therefore, the bridge device may receive MS/TP communications from the first MS/TP network segment and/or the second MS/TP network segment.

In some embodiments, the bridge device selectively forwards the MS/TP packets based on a security configuration. For example, the security configuration may relate to identifying the BACnet devices involved in the MS/TP communication (e.g., the originating device, the recipient device, etc.) and implement various rules that dictate which BACnet devices can communicate with other BACnet devices and/or what sort of communications one BACnet device can provide to another BACnet device (e.g., read commands, write commands, etc.) In other embodiments, the security configuration may relate to the MS/TP network segments in general and implement various rules that dictate which BACnet devices can send messages across the bridge device to the opposite MS/TP network segment and/or what sort of MS/TP communications are allowed to cross the bridge device to the from one MS/TP network segment to the opposite MS/TP network segment.

In some embodiments, the bridge device receives an MS/TP packet and identifies one or more pieces of information contained in the MS/TP packet to determine whether or not to selectively forward the MS/TP packet to the opposite MS/TP network segment and/or the intended recipient of the communication. The MS/TP packet may generally include MS/TP-related information (e.g., source MS/TP address, destination MS/TP address, MS/TP message type, etc.), Network Protocol Data Unit (NPDU)-related information (e.g., network source media access control (MAC) layer, network source number, network destination number, network destination MAC layer, etc.), and/or Application Protocol Data Unit (APDU)-related information (e.g., BACnet service type, BACnet service data, etc.). As discussed above and in further detail below, the bridge device selectively forwards the MS/TP packet based on the security configuration. The security configuration may be a number of rules relating to information identified from the MS/TP packet. For example, the bridge device may reference the security configuration and/or the number of rules, identify the relevant information from the MS/TP packet (e.g., the information that is applicable to the number of rules), and apply the number of rules to the identified information. The bridge device may then make a determination whether to selectively forward the MS/TP packet.

In some embodiments, the bridge device automatically detects BACnet devices on its MS/TP communication bus and automatically assigns an MS/TP address to the BACnet device. Automatically detecting MS/TP devices and assigning wireless addresses allows the bridge device to be implemented transparently such that BACnet devices to be operationally unaware in some embodiments. In some embodiments, the bridge device automatically notifies other bridge devices on its network upon detection of a BACnet device on its bus.

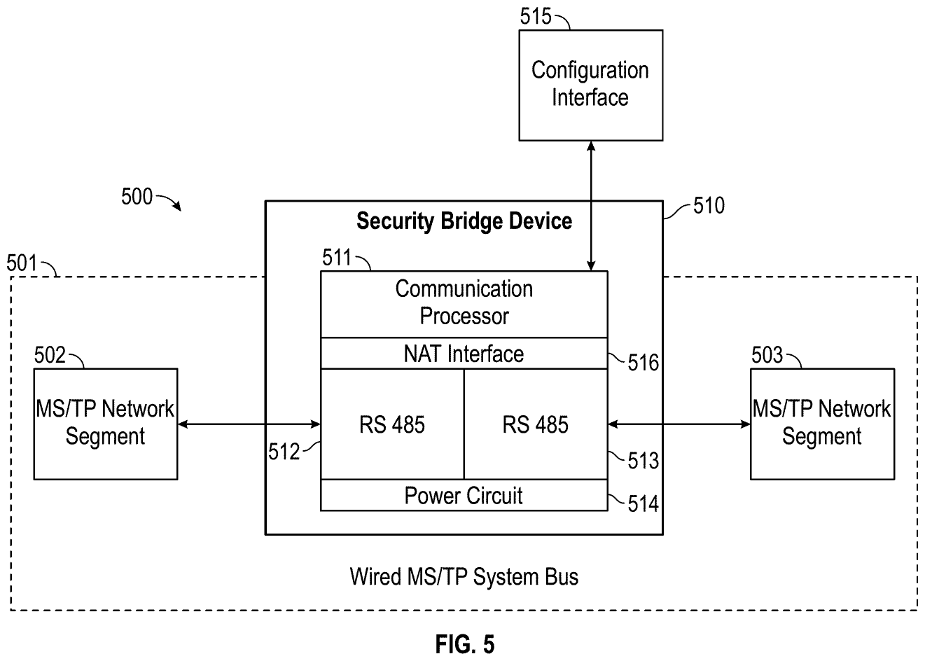

Referring now to FIG. 5, a building system, such as a building system including one or more of the components discussed in FIGS. 1-4, can include a security bridge device 510. The bridge device 510 includes a communications processor 511, a first wired interface 512, and a second wired interface 513. As shown, the bridge device 510 is locally configured. The bridge device 510 is coupled to a wired network 500, such as a wired MS/TP network (e.g., BACnet MS/TP network). The wired network 500 includes a wired MS/TP system bus 501 (e.g., a communication bus). The wired MS/TP system bus 501 includes a first MS/TP network segment 502 and a second MS/TP network segment 503. The bridge device 510 is connected directly to a segment of the wired MS/TP system bus 501 via the first wired interface 512 coupling to the first MS/TP network segment 502 and via the second wired interface 513 coupling to the second MS/TP network segment 503. In other embodiments, the bridge device 510 is connected to an MS/TP port of a BACnet device (controller, actuator, sensor, lighting devices, security devices, any HVAC device discussed above, etc.) via the first wired interface 512 and/or the second wired interface 513. In some embodiments, both the first MS/TP network segment 502 and the second MS/TP network segment 503 are coupled to a single wired interface, such as the first wired interface 512.

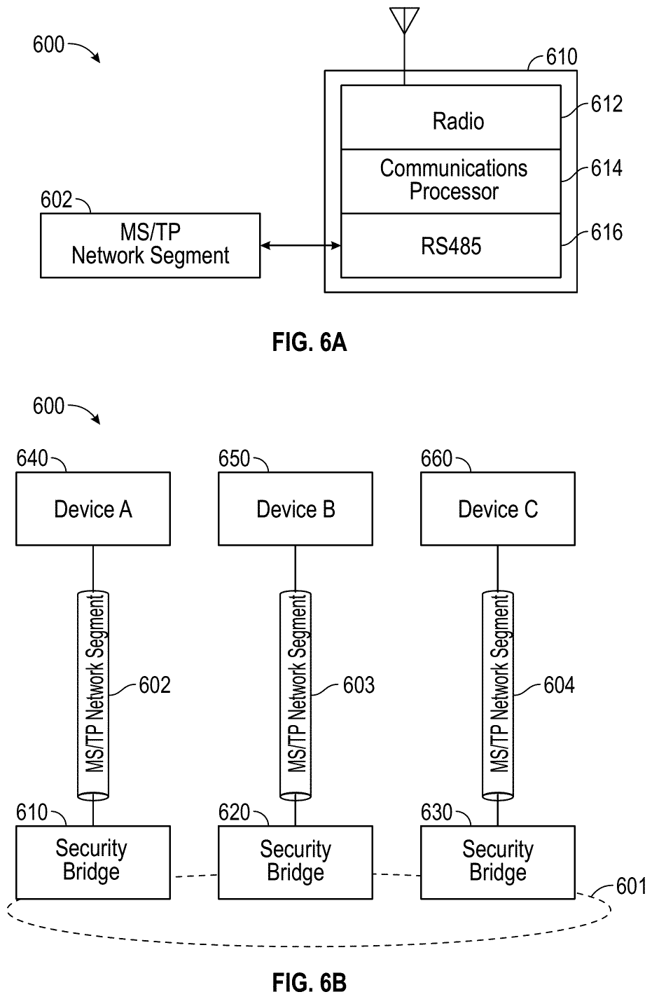

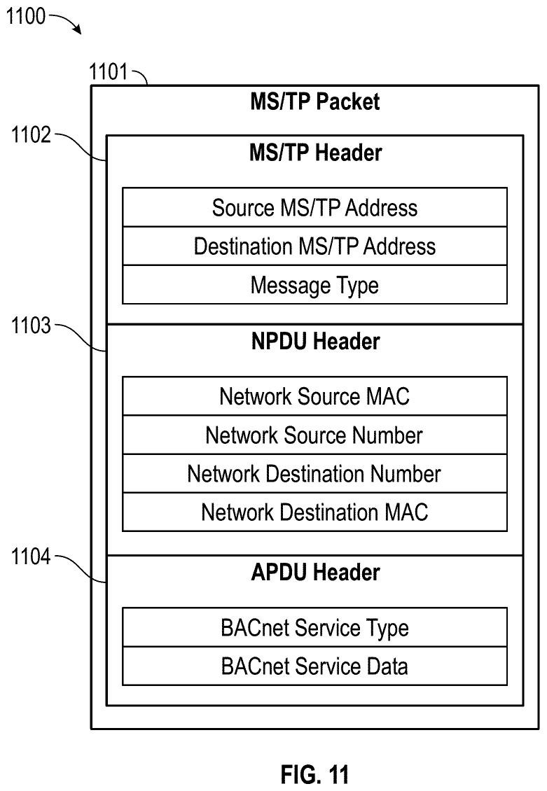

In some embodiments, the first wired interface 512 is a communications interface (e.g., including a RS-485 interface). The first wired interface 512 includes a RS-485 serial port for communication with the wired network 500. The second wired interface 513 may be similar to the first wired interface 512. The wired network 500 can be coupled with wired devices (e.g., BACnet devices, MS/TP devices, etc.), such as HVAC devices, lighting devices, security devices, etc. In some embodiments, the wired network 500 is coupled to building devices associated with a BMS. The wired MS/TP system bus 501 can include any of a variety of communications hardware (e.g., wire, optical fiber, terminals, etc.) configured to facilitate communications between the wired devices connected to the wired MS/TP system bus 501. In some embodiments the bridge device 510 can be configured to wirelessly communicate with other bridge devices on a wireless network, as shown in FIG. 6. In some embodiments, the bridge device 510 receives an MS/TP packet, such as the MS/TP packet depicted in FIG. 11, via the first wired interface 512 or the second wired interface 513. For example, the MS/TP packet may be provided by a BACnet device connected to the first MS/TP network segment 502 intending to send the MS/TP packet to another BACnet device connected to the second MS/TP network segment 503. Similarly, the MS/TP packet may be provided by a BACnet device connected to the second MS/TP network segment 503 intending to send the MS/TP packet to another BACnet device connected to the first MS/TP network segment 502.

In some embodiments, the communications processor 511 includes memory. The communications processor 511 executes firmware stored in memory and performs or supervises media access control (MAC) layer and physical layer operations. The communications processor 511 receives communications (e.g. MS/TP packets, BACnet commands, etc.) from one or more BACnet devices located on the first MS/TP network segment 502 side of the wired MS/TP system bus 501, evaluates the MS/TP packets, and determines whether to forward the one or more of the MS/TP packets along the second MS/TP network segment 503 to the appropriate BACnet device(s) of the wired MS/TP system bus 501. Likewise, the communications processor 511 receives MS/TP packets from one or more BACnet devices located on the second MS/TP network segment 503 side of the wired MS/TP system bus 501, evaluates the MS/TP packets, and determines whether to forward one or more of the MS/TP packets along the first MS/TP network segment 502 to the appropriate BACnet device(s) on the wired MS/TP system bus 501. The communications processor 511 may receive MS/TP packets via the first wired interface 512 and/or the second wired interface 513 as described above.

In some embodiments, the communications processor 511 of bridge device 510 uses software to automatically discover the BACnet devices that are present on the wired network 500 or the wired MS/TP system bus 501. Automatic discovery can be achieved by monitoring the token on the wired network 500 or the wired MS/TP system bus 501 to determine which BACnet devices are actually communicating and using the token in some embodiments. In some embodiments, automatic discovery can be achieved by inspecting the messages that are being communicated on the wired network 500 or the wired MS/TP system bus 501 to discover messages and addresses. For example, if a BACnet device is present and the bridge device 510 receives a message through the first wired interface 512, the bridge device 510 determines the address is present on the wired network 500 and determines that the address is present on the first MS/TP network segment 502 side of the wired MS/TP system bus 501. Likewise, if a BACnet device is present and the bridge device 510 receives a message through the second wired interface 513, the bridge device 510 determines the address is present on the wired network 500 and determines that the address is present on the second MS/TP network segment 503 side of the wired MS/TP system bus 501. In some embodiments, automatic discovery can occur using a single wired interface, such as the first wired interface 512, that interfaces with both sides of the network 500 and determines which side of the wired MS/TP system bus 501 the address is present on. Automatic discovery is performed in the media access control (MAC) layer of the bridge device 510 in some embodiments.

In some embodiments, automatically detecting BACnet devices and assigning wireless addresses allows the bridge device 510 to be implemented transparently such that BACnet devices to be operationally unaware of the bridge device 510. In some embodiments, the bridge device 510 is capable of automatically notifying other bridge devices on its network, via a wireless connection, upon detection of a BACnet device on its bus, as described in further detail in regards to FIG. 6.

In some embodiments, the communications processor 511 can be configured to perform some and/or all of the functionality of bridge device 510. In some embodiments, the communications processor 511 is configured to perform some or all of the functionality necessary for connecting to the wired network 500. The communications processor 511 can be a general purpose or specific purpose processor, an application specific integrated circuit (ASIC), one or more field programmable gate arrays (FPGAs), a group of processing components, or other suitable processing components. The communications processor 511 may be configured to execute computer code and/or instructions stored in memory or received from other computer readable media (e.g., CDROM, network storage, a remote server, etc.). In some embodiments, the memory stores a Linux operating system, the Linux operating system can facilitate some and/or all of the functionality of the components of the memory. The memory can include one or more devices (e.g., memory units, memory devices, storage devices, etc.) for storing data and/or computer code for completing and/or facilitating the various processes described in the present disclosure. In some embodiments, the memory stores data and/or computer code for completing and/or facilitating the various processes relevant to the operation of communications. The memory can include random access memory (RAM), read-only memory (ROM), hard drive storage, temporary storage, non-volatile memory, flash memory, optical memory, or any other suitable memory for storing software objects and/or computer instructions. The memory can include database components, object code components, script components, or any other type of information structure for supporting the various activities and information structures for bridge device 510.

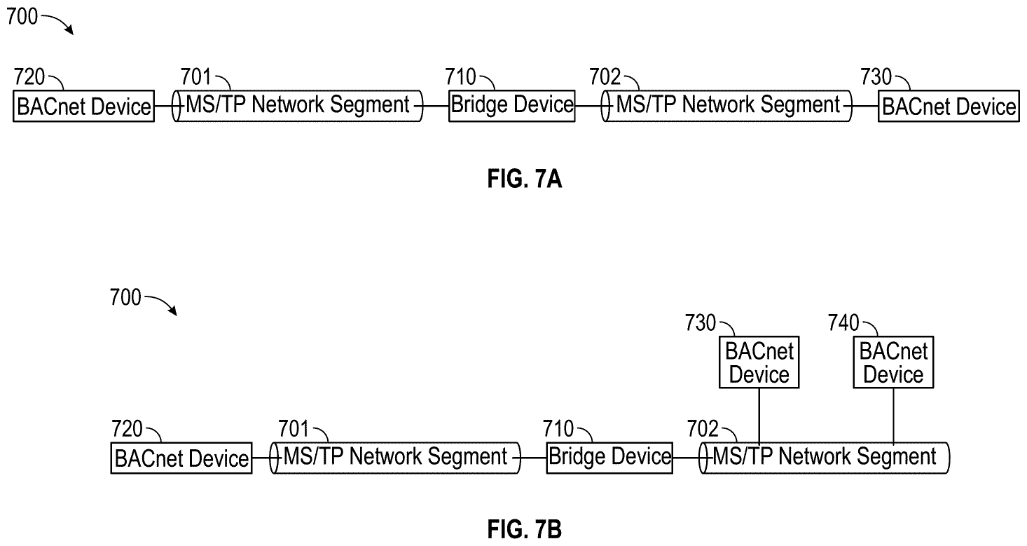

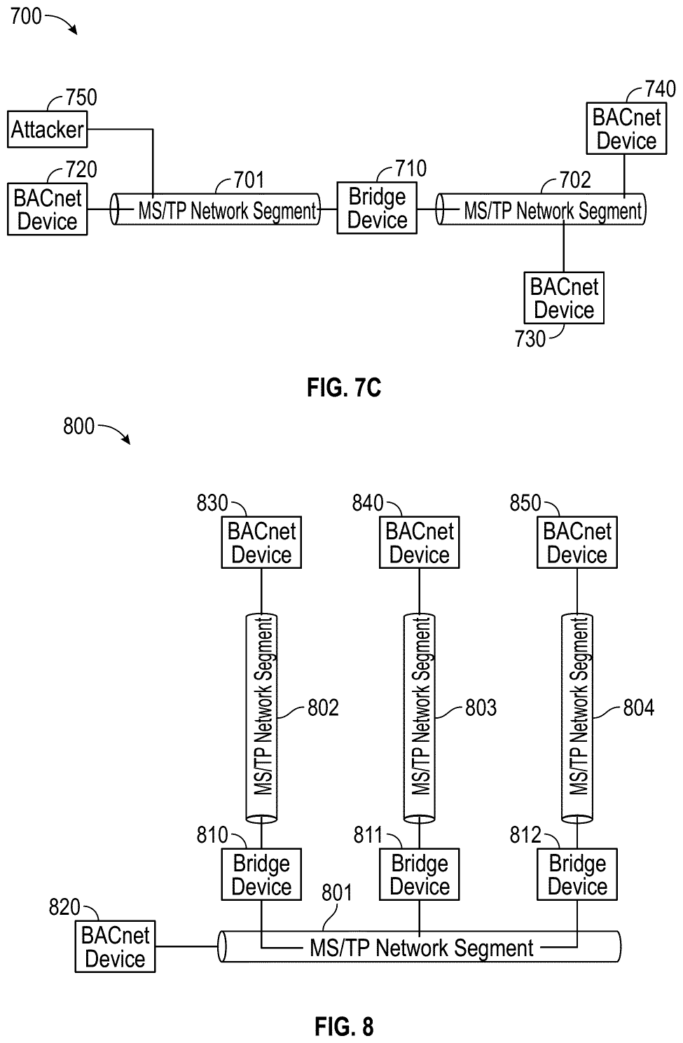

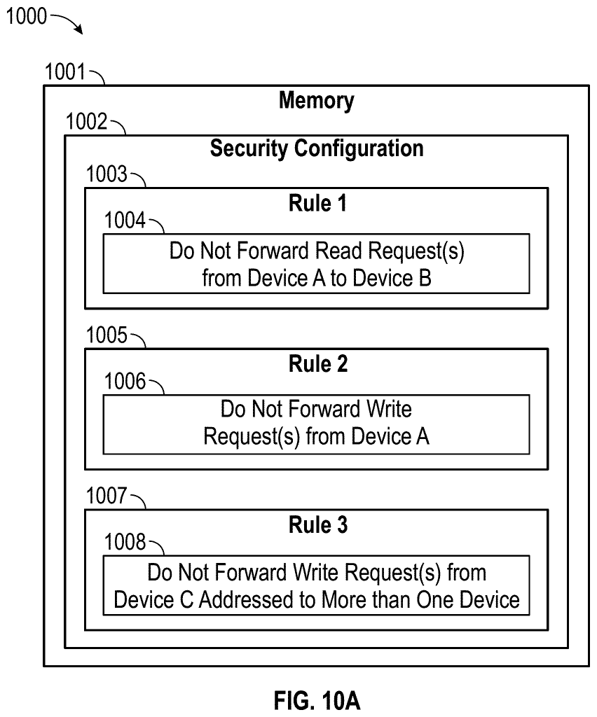

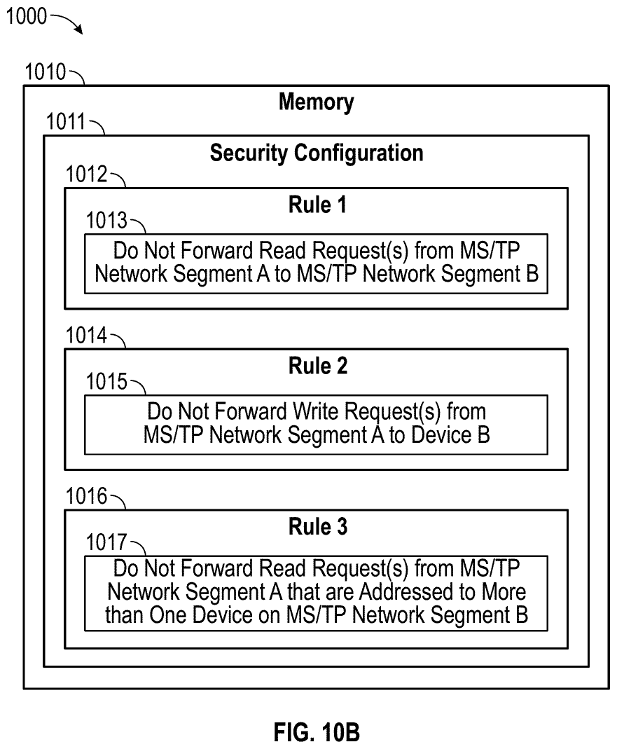

In some embodiments, the communications processor 511 identifies information from an MS/TP packet (received via the first wired interface 512 and/or the second wired interface 513) that is relevant for making a determination for selectively forwarding the MS/TP packet. The determination may be based on a security configuration. In some embodiments, the memory stores the security configuration. For example, the security configuration may form a set of rules, as described in greater detail in FIGS. 10A and 10B. The rules may provide a structure for determining, via the communications processor 511, whether to selectively forward an MS/TP packet, as described in greater detail regarding FIGS. 7A, 7B, 7C, and 8.

In some embodiments, the bridge device 510 is connected to a configuration interface (e.g., a separate interface) 515. The configuration interface 515 may provide the communications processor 511 with an initial security configuration, a replacement security configuration, or edits to an existing security configuration. The configuration interface 515 may be connected to the bridge device 510 via wired or wireless connection. In some embodiments, the configuration interface 515 may be a device on the network 500 that is configured to automatically adjust the security configuration of the communications processor 511 in response to various changes to the network or security protocols. In other embodiments, the configuration interface 515 may be a component of a management device on the network 500. In other embodiments still, the configuration interface 515 may be a user device including a user interface. In this way, a technician can manually provide, edit, or replace the security configuration of the communications processor 511.

In some embodiments, the bridge device 500 further includes a power circuit 514. The power circuit 514 may be connected to the first wired interface 512 and/or the second wired interface 513, or the first wired interface 512 and the second wired interface 513 may be combined and the power circuit 514 may be included in the wired combination. The power circuit 514 may convert the transmission of MS/TP packets through the first and second wired interfaces 512 and 513 into electrical energy to be used by the bridge device 510. In this way, the bridge device 510 may be a low-power device configured to provide its own power source drawn from the operation of the network 500.

In some embodiments, the bridge device 510 further includes a Network Answer Translation (NAT) interface 516. The NAT interface 516 may be connected to the communications processor 511 and provide additional functionality to the communications processor 511. For example, the NAT interface 516 may interact with the communications processor 511 to implement an overall NAT system where communications received by the bridge device 510 via the second wired interface 513 are forwarded to the first MS/TP network segment 502 based on a secondary security configuration. The secondary configuration may instruct the communications processor 511 to only allow BACnet responses to BACnet requests received and forwarded by the bridge device 510.

Referring now to FIGS. 6A, a building system, such as a building system including one or more of the components discussed in FIGS. 1-4, can include a first wireless security bridge device 610. The first bridge device 610 includes a communications processor 614, a radio 612, and a wired interface 616. As shown, the first bridge device 610 is wirelessly configured to communicate with other bridge devices, as depicted in further detail in FIG. 6B. The first bridge device 610 may use the radio 612 to communicate on a wireless network, such as a wireless systems bus 601 depicted in FIG. 6B. The first bridge device 610 may be connected to a first MS/TP network segment 602 via the wired interface 616. The wireless systems bus 601 may form part or all of a network 600. Although not shown, the first bridge device 610 may include a second wired interface connected to a second MS/TP network segment. In this way, the first bridge device 610 would be configured to operate with similar functionality as that of the bridge device 510 depicted in FIG. 5, with the added capabilities of communicating with other bridge devices, as described in further detail regarding FIG. 6B.

In some embodiments, the radio 612 is a wireless network radio for communication with other wireless devices, such as a second bridge device 620 depicted in FIG. 6B. Depending on the radio technology in the first bridge device 610, the network 600 can be a Zigbee network using an 802.15.4 radio, WiFi network using an 802.11 radio, a Bluetooth mesh network, Wi-Fi (star, mesh, Direct) network, etc. The radio 612 can be configured to communicate on the network 600 via Wi-Fi, ZigBee (e.g., ZigBee IP, ZigBee Pro Green Power), Bluetooth, LoRa, a local area network (LAN), a metropolitan area network (MAN), a wide area network (WAN) (e.g., the Internet), ad hoc wireless communication (e.g., MANET, VANET, SPANET, iMANET), and/or any other type of wireless communication. The second radio 613 may be similar to the radio 612.

Referring now to FIG. 6B, a number of wireless bridge devices are shown communicating on the network 600 depicted in FIG. 6A via the wireless systems bus 601. As shown, the network 600 includes a first bridge device, such as the first bridge device 610 depicted in FIG. 6A, a second bridge device 620, and a third bridge device 630. The first bridge device 610 is connected to a first MS/TP network segment 602, the second bridge device 620 is connected to a second MS/TP network segment 603, and the third bridge device 630 is connected to a third MS/TP network segment 604. As shown, the first, second, and third bridge devices 610, 620, and 630, can communicate wirelessly with one another via the wireless systems bus 601. For example, each of the first bridge device 610, second bridge device 620, and third bridge device 630 may include a radio, such as the radio 612 depicted in FIG. 6A. In this way, the bridge devices may form a point-to-point network on the network 600. For example, the first bridge device 610 may provide the second bridge device 620 and/or the third bridge device 630 with one or more security alerts regarding the determination that one or more MS/TP packets could not be forwarded as dictated by the security configuration.

Referring now to FIG. 7A, a wired network 700 includes a bridge device 710, a first MS/TP network segment 701, and a second MS/TP network segment 702. The bridge device 710 may be similar to the bridge device 510 depicted in FIG. 5. The first MS/TP network segment 701 is coupled to a first BACnet device 720. The second MS/TP network segment 702 is coupled to a second BACnet device 730. The bridge device 710 is locally configured, as described in relation to the bridge device 510 depicted in FIG. 5. The bridge device 710 may include a communications processor, such as the communications processor 511 depicted in FIG. 5, to selectively forward MS/TP packets between the first MS/TP network segment 701 and the second MS/TP network segment 702. As described in regards to FIG. 5, memory stored in the communications processor 511 may include a security configuration that forms a number of rules for making a determination whether to forward an MS/TP packet.

In some embodiments, the rules are related to a BACnet device (such as the first BACnet device 720) that provided the MS/TP packet. For example, and described in greater detail below in regards to FIG. 11, the identify of the BACnet device may be determined via an MS/TP address that may be identified from the MS/TP packet via the communications processor 511. In other embodiments, the rules are related to the MS/TP network segment (e.g., the first MS/TP network segment 701 and/or the second network segment 702, for example) that the MS/TP packet arrives to the bridge device 710 from. In other embodiments, the rules are related to the type and/or function of the MS/TP packet. For example, the MS/TP packet may be a read request or a write request from the first BACnet device 720. In other embodiments still, the rules may relate to various combinations of these factors, as described in greater detail below in FIG. 11.

As an example, the security configuration may instruct the bridge device 710 to forward read requests from the first BACnet device 720 from the first MS/TP network segment 701 to the second MS/TP network segment 702, but not write requests. As another example, the security configuration may instruct the bridge device 710 to forward an MS/TP packet from the first BACnet device 720 from the first MS/TP network segment 701 to the second MS/TP network segment 702, but only if the second BACnet device 730 is the recipient detailed in the MS/TP packet. As another example, the security configuration may instruct the bridge device 710 to forward an MS/TP packet from the first MS/TP network segment 701 to the second network segment 702 (regardless of the particular BACnet device providing the MS/TP packet), but only if the MS/TP packet includes a read request. As one of skill in the art could appreciate, there are numerous combinations of rules that could be applied in the security configuration. As such, these examples are intended to merely be illustrative embodiments and non-limiting examples.

Referring now to FIG. 7B, the wired network 700 depicted in FIG. 7A further includes a third BACnet device 740 coupled to the second MS/TP network segment 702, in some embodiments. Providing further examples to the non-limiting examples discussed above in regards to FIG. 7A, the security configuration may instruct the bridge device 710 to forward an MS/TP packet from the first BACnet device 720 (or any device connected to the first MS/TP network segment 701) to one of the second and third BACnet devices 730 and 740 but not the other. In another example, the security configuration may instruct the bridge device 710 to forward an MS/TP packet from the fist BACnet device 720 to either of the second and third BACnet devices 730 and/or 740, but only if it is a read request. In another example, the security configuration may instruct the bridge device 710 to forward an MS/TP packet from any device connected to the first MS/TP network segment 701, but only if it is a global command to the second MS/TP network segment 702 (e.g., a command to be distributed to every device connected to the second MS/TP network segment 702. As stated in regards to FIG. 7A, it should be appreciated that the possible arrangement of rules and ultimate security configurations are numerous by nature.

Referring now to FIG. 7C, the wired network 700 depicted in FIG. 7B further includes an attacker device 750 coupled to the first MS/TP network segment 701, according to some embodiments. The attacker device 750 may be a third party and/or hostile device inserted onto the wired network 700 by a third party to inject communications onto the MS/TP system bus formed by the first MS/TP network segment 701 and the second MS/TP network segment 702 to manipulate the second BACnet device 730 and/or the third BACnet device 740. In some embodiments, the attacker device 750 may be configured to mimic certain properties of the first BACnet device 720. For example, the attacker device 750 may be configured to provide the same BACnet commands that the first BACnet device 720 would otherwise provide. In some embodiments, the security configuration may instruct the bridge device 710 to not forward MS/TP packets from an MS/TP address that is not the MS/TP address of the first BACnet device 720. In this way, the bridge device 710 may prevent the attacker device from infiltrating an MS/TP communication bus due to the foreign MS/TP address associated with the attacker device 750, while allowing the first BACnet device 720 to continue communicating with the second and third BACnet devices 730 and 740 as normal. As another example, the attacker device 750 may be configured to mimic the MS/TP address of the first BACnet device 720. In some embodiments, the security configuration may instruct the bridge device 710 not to forward an MS/TP packet that includes BACnet commands other than read commands. In this way, the bridge device 710 may prevent unwanted manipulation of the second and third BACnet devices 730 and 740 even in the event that a hostile device successfully mimics the specific identity or address of a known BACnet device, such as the first BACnet device 720. As stated in regards to FIGS. 7A and 7B, it should be appreciated that the possible arrangement of rules and ultimate security configurations are numerous by nature.

Referring now to FIG. 8, a wired network 800 includes a number of bridge devices. The number of bridge devices includes a first bridge device 810, a second bridge device 811, and a third bridge device 812. The bridge devices 810-812 are coupled to a first MS/TP network segment 801. The bridge devices 810-812 may prevent a number of BACnet devices from receiving unwanted MS/TP communications from a first BACnet device 820 on a per-device basis. The number of BACnet devices includes a second BACnet device 830 coupled to the first bridge device 810 via a second MS/TP network segment 802, a third BACnet device 840 coupled to the second bridge device 811 via a third MS/TP network segment 803, and a fourth BACnet device 850 coupled to the third bridge device 812 via a fourth MS/TP network segment 804. The bridge devices 810-812 may have equivalent or individual security configurations. In this way, if an attacker device, such as the attacker device 750 depicted in FIG. 7C, intercepts the MS/TP network such that there is no bridge device in between the attacker device 740 and a BACnet device (for example, the attacker device 750 could connect to the first MS/TP network segment 802), while the attacker device may be able to provide unwanted MS/TP packets to the unprotected device (the first BACnet device 830 in this example), the remaining BACnet devices on the network (the second and third BACnet devices 840 and 850 in this example) would still be guarded against unwanted communication by at least their own individual bridge devices (the second and third bridge devices 811 and 812 in this example).

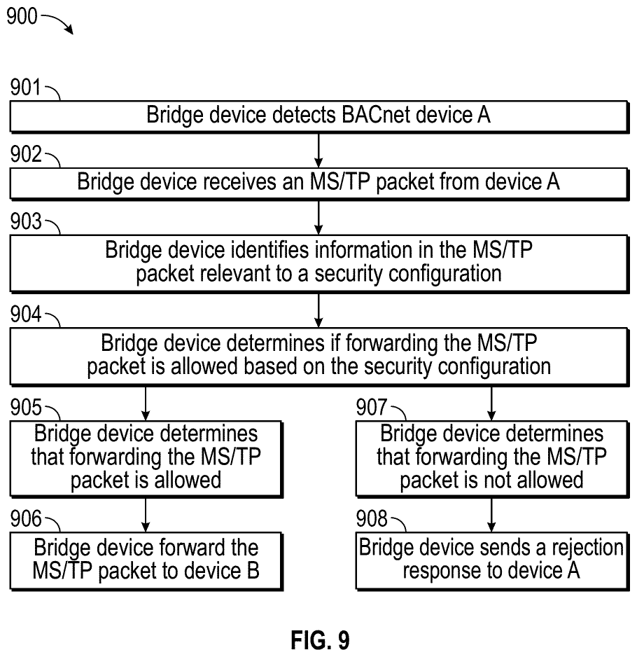

With respect to FIGS. 7A and 9, a flow 900 can be performed in wired network 700. Flow 900 can also be performed in networks 500, 600, and 800. A bridge device (e.g., bridge device 710) detects a BACnet device (A) (e.g. first BACnet device 720) on an MS/TP communication bus (e.g., the first MS/TP network segment 701 depicted in FIG. 7A) in an operation 901. As described in relation to FIG. 5, the bridge device may detect the BACnet device A automatically. After the bridge device detects the BACnet device A, the bridge device may receive (e.g., intercept) an MS/TP packet from the BACnet device A intended to be provided to a BACnet device B elsewhere on the MS/TP communication bus (e.g., the second MS/TP network segment 702). As discussed above in regards to FIG. 5, the BACnet device A may be operationally unaware that the bridge device has received and/or intercepted the MS/TP packet it sent. The bridge device then uses a security configuration (for example, accessing the memory included in the communications processor 511 depicted in FIG. 5) to determine relevant information to identify in the MS/TP packet in operation 903. In some embodiments, the bridge device reviews and compiles all of the information included in the MS/TP packet before referencing the security configuration. Using rules formed by the security configuration, the bridge device determines if forwarding the MS/TP packet is allowed based on the security configuration in operation 904. Operations 903 and 904 are discussed in greater detail in regards to FIGS. 10A, 10B, and 11. If the bridge device determines that forwarding the MS/TP packet is allowed (e.g, determines to selectively forward the MS/TP packet), the flow 900 follows an option 905. If the bridge device determines that forwarding the MS/TP packet is not allowed (e.g., determines to not selectively forward the MS/TP packet), the flow 900 follows an option 906.

In the case of option 907, the bridge device determines that forwarding the MS/TP packet is not allowed. In some embodiments, the bridge device proceeds to provide the BACnet device A with a rejection response in an operation 908. In some embodiments, the rejection response may proxy the identity of the intended BACnet device recipient of the MS/TP packet. In some embodiments, the rejection response may maintain the timing of MS/TP communications on a MS/TP communication bus, such as the wired MS/TP system bus 501 depicted in FIG. 5, to prevent errors on the wired MS/TP system bus 501. In other embodiments, the bridge device simply removes the MS/TP packet from the wired MS/TP system bus 501 and provides no response to the BACnet device A. For example, it may be advantageous to avoid providing any data or communications to certain hostile devices (such as the attacker device 750 depicted in FIG. 7C).

Referring now to FIG. 10A, a memory (such as the memory of the communications processor 511 depicted in FIG. 5) of a bridge device (such as the bridge device 710 depicted in FIG. 7C) on a network 1000 is shown, according to one embodiment. As shown, a memory 1001 includes a security configuration 1002. The security configuration 1002 may be partitioned to form one or more rules for the operation of the communications processor 511. As shown, the security configuration 1002 includes a first rule 1003, a second rule 1005, and a third rule 1007. Each of the rules is configured to store a logic to be implemented in the function of the communications processor 511. For example, the first rule 1003 includes a first logic 1004, which states: “Do not forward read request(s) from device A (such as the first BACnet device 720 depicted in FIG. 7C) to Device B (such as the second BACnet device 730 depicted in FIG. 7C).” For example, the first BACnet device 720 may provide an MS/TP packet along the first MS/TP network segment 701 (depicted in FIG. 7C). The bridge device 710 would then intercept the MS/TP packet and determine whether to forward the MS/TP packet along the second MS/TP network segment 702 (depicted in FIG. 7C). The communications processor 511 would then access the memory 1001 to obtain the security configuration 1002 and reference the first, second, and third rules 1003, 1005, and 1007. The communications processor 511 would then reference the information included in the MS/TP packet (explained in further detail below in regards to FIG. 11) to determine whether any of the rules apply to the MS/TP packet. In this sense, communications processor 511 would allow the bridge device 710 to forward the MS/TP packet if no rules expressly disallow forwarding the MS/TP packet.

In some embodiments, the security configuration 1002 can be configured to not forward the MS/TP packet unless a rule expressly states that forwarding the MS/TP packet is allowed. In the present example, however, the communications processor may review the MS/TP packet and determine that the first BACnet device 720 that provided the MS/TP packet is “Device A.” For example, the communications processor may make this determination based on MS/TP address information or NPDU information (described in greater detail below in regards to FIG. 11). The communications processor 511 may further apply the MS/TP address information to determine that the second BACnet device 730 is “Device B.” Finally, the communications processor may identify that the BACnet service type of the MS/TP packet is a read command (described in greater detail below in FIG. 11). In this case, the rule would be applied and the MS/TP packet would be rejected. As shown, second rule 1005 and third rule 1007 include second logic 1006 and third logic 1008 to address other scenarios that may be applicable for maintaining the security of the network 1000.

Referring now to FIG. 10A, a memory (such as the memory of the communications processor 511 depicted in FIG. 5) of a bridge device (such as the bridge device 710 depicted in FIG. 7C) on a network 1000 is shown, according to one embodiment. As shown, a memory 1010 includes a security configuration 1011, the security configuration includes a first rule 1013, a second rule 1014, and a third rule 1016. The first rule 1012 includes a first logic statement 1013, the second rule 1014 includes a second logic statement 1015, and the third rule 1016 includes a third logic statement 1017. As shown, the security configuration 1012 generally operates as described in reference to FIG. 10A. However, as shown by the first, second, and third logic statements 1013, 1015, and 1017, logic statements can relate to the selective forwarding of MS/TP packets from one MS/TP network segment to another. As described above in FIG. 10A, the first, second, and third logic statements 1004, 1006, and 1008 were directed towards the forwarding of an MS/TP packet from one BACnet device to another BACnet device. In some embodiments, a security configuration may include various combinations of logic statements concerned with transmissions between BACnet devices and/or MS/TP network segments.

Referring to FIGS. 10A and 10B, it should be appreciated that, while depicted in plain terms, the logic statements may be articulated in any manner appropriate for actual operation of a communications processor. For example, the logic statements may be implemented in a memory of a communications processor as machine-readable media.

Referring now to FIG. 11, the an MS/TP packet 1101 to be communicated on a network 1100 is shown, according to one embodiment. The MS/TP 1101 packet may be organized by one or more headers. As shown, the MS/TP packet is organized as an MS/TP header 1102, an NPDU header 1103, and an APDU header 1104. The MS/TP header 1102, the NPDU header 1103, and the APDU header may be further organized into particular items of information as shown. For example, the MS/TP header includes “Source MS/TP Address” information, “Destination MS/TP address information,” and “Message Type” information. As described above, the MS/TP packet 1101 may be intercepted or received by a bridge device, such as the bridge device 710 depicted in FIG. 7. Upon intercepting or receiving the MS/TP packet 1101, the bridge device 710, via a communications processor, such as the communications processor 511 depicted in FIG. 5 may first reference a security configuration, such as the security configuration 1002 depicted in FIG. 10A. By referencing the security configuration 1002, the communications processor 511 may determine particular headers of the MS/TP packet 1101 to search for relevant information. For example, after interpreting the rule 1003 of the security configuration 1002, the communications processor 511 may only identify relevant headers and/or pieces of information included in the headers of the MS/TP packet 1101, such as the MS/TP header (e.g., “Source MS/TP address, destination MS/TP address, etc.). In some embodiments, the communications processor 511 may interpret and compile all of the information stored in the MS/TP packet before referencing the security configuration 1002. As shown, the MS/TP packet 1101 may include numerous types of information relating to the transmission of the MS/TP packet 1101. Accordingly, it should be appreciated that the number of potential rules included in a security configuration are numerous in nature and the embodiments described herein should not be interpreted as limiting.

The various bridge devices described in relation to FIGS. 5-11 advantageously improve the function of a computer, network, or building management system. A computer, network, or building management system may integrate one or more of the bridge devices as described to improve security against unwanted communications or improve a network firewall against communications from third party and/or hostile devices, thereby improving the operational efficiency and robustness of the communication network. Specifically, the bridge devices improve the function of an MS/TP communication bus by improving security against MS/TP packet injections on a portion of the MS/TP bus should a third party gain access to a portion of the MS/TP bus in some embodiments.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a number of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of various systems (e.g., HVAC system 100, system 200, etc.) and methods as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A building management system communication network configured to reduce security risk, the network comprising:
a Master-Slave/Token Passing (MS/TP) communication bus;
a plurality of Building Automation Control network (BACnet) devices coupled to the MS/TP communication bus, the plurality of BACnet devices comprising a first BACnet device coupled to the first MS/TP communication bus and a second BACnet device coupled to the MS/TP communication bus;
a plurality of bridge devices coupled to the MS/TP communication bus, the plurality of bridge devices comprising a first bridge device, the first bridge device located on the MS/TP communication bus between the first BACnet device and the second BACnet device, the first bridge device comprising a processing circuit and a memory, the processing circuit configured to:
receive a first MS/TP packet from the first BACnet device, and
selectively forward the first MS/TP packet to the second BACnet device based on a first security configuration, the first security configuration stored in the memory.

2. The network of claim 1, wherein the processing circuit is further configured to automatically detect the plurality of BACnet devices.

3. The network of claim 1, wherein the network further comprises a management device, the management device configured to provide the first security configuration to the memory.

4. The network of claim 3, wherein the management device is a user device comprising a user interface, the user interface configured to allow a user to configure the first security configuration.

5. The network of claim 1, wherein:
the first MS/TP packet comprises at least one of MS/TP address information; Network Protocol Data Unit (NPDU) information; or Application Protocol Data Unit (APDU) information,
the processing circuit is configured to identify the at least one of MS/TP address information; NPDU information; or APDU information from the MS/TP packet, and
the first security configuration is based on the at least one of MS/TP information; NPDU information; or APDU information.

6. The network of claim 1, wherein:
the first MS/TP packet comprises a BACnet request,
the processing circuit is further configured to identify a BACnet service type from the BACnet request, and
the first security configuration is based on the BACnet service type.

7. The network of claim 1, wherein:
the first MS/TP packet comprises a BACnet request,
the bridge device further comprises a Network Answer Translation (NAT) interface coupled to the processing circuit, the NAT interface configured to provide the processing circuit with a second security configuration,
the processing circuit is further configured to selectively forward a second MS/TP packet from the second BACnet device to the first BACnet device based on the second security configuration, and
the second security configuration is configured such that the processing circuit does not selectively forward the second MS/TP packet unless the second MS/TP packet comprises a BACnet response to the BACnet request.

8. The network of claim 1, wherein:
the processing circuit is further configured to automatically provide to the first BACnet device with a second MS/TP packet responsive to the first MS/TP packet not being selectively forwarded to the second BACnet device based on the security configuration, and
the second MS/TP packet comprises:
a rejection response; and
information to proxy the second BACnet device as a provider of the second MS/TP packet.

9. The network of claim 1, wherein the first bridge device is coupled to the MS/TP communication bus transparently, such that the first BACnet device and the second BACnet device are operationally unaware of the first bridge device.

10. The network of claim 1, wherein the plurality of bridge devices are configured to communicate wirelessly with one another, such that the plurality of bridge devices form a point-to-point wireless network.

11. A method for reducing security risk on a building management system communication network comprising a Master-Slave/Token Passing (MS/TP) communication bus, and a plurality of Building Automation Control network (BACnet) devices coupled to the MS/TP communication bus, the plurality of BACnet devices comprising a first BACnet device and a second BACnet device, the method comprising:
providing a bridge device coupled to the MS/TP communication bus and located between the first BACnet device and the second BACnet device, wherein the bridge device comprises a processing circuit;
receiving, by the processing circuit, a first MS/TP packet from the first BACnet device;
identifying, by the processing circuit, at least one of MS/TP address information, Network Protocol Data Unit (NPDU) information, and Application Protocol Data Unit (APDU) information, from the first MS/TP packet;
configuring, by the processing circuit, a first security configuration, wherein the first security configuration is based on the at least one of the MS/TP address information, NPDU information, or APDU information; and
selectively forwarding, by the processing circuit, the first MS/TP packet to the second BACnet device, based on the first security configuration.

12. The method of claim 11, further comprising automatically detecting, via the processing circuit, the plurality of BACnet devices.

13. The method of claim 11, further comprising automatically providing a second MS/TP packet to the first BACnet device responsive to the first MS/TP packet not being selectively forwarded to the second BACnet device based on the first security configuration, wherein the second MS/TP packet comprises:
a rejection response; and
information to proxy the second BACnet device as a provider of the second MS/TP packet.

14. The method of claim 11, wherein the bridge device is coupled to the MS/TP communication bus and located between the first BACnet device and the second BACnet device transparently, such that the first BACnet device and the second BACnet device are operationally unaware of the bridge device.

15. The method of claim 11, wherein the bridge device further comprises a Network Answer Translation (NAT) interface coupled to the processing circuit, wherein the method further comprising:
configuring, by the NAT interface, a second security configuration;
providing, by the NAT interface, the second security configuration to the processing circuit;
identifying, by the processing circuit, that the first MS/TP packet comprises a BACnet request; and
selectively forwarding, by the processing circuit, a second MS/TP packet from the second BACnet device to the first BACnet device based on the second security configuration, wherein the second security configuration is configured such that the processing circuit does not selectively forward the second MS/TP packet unless the second MS/TP packet comprises a BACnet response to the BACnet request.

16. A bridge device for reducing security risk on a building management system communication network, the bridge device comprising:
a first interface coupled to a first Master-Slave/Token Passing (MS/TP) network segment of an MS/TP communication bus;
a second interface coupled to a second network segment of the MS/TP communication bus; and
a communications processor, the communications processor configured to:
receive an MS/TP packet from the first MS/TP network segment via the first interface, and
selectively forward the MS/TP packet to the second MS/TP network segment via the second interface based on a security configuration.

17. The bridge device of claim 16, wherein:
the bridge device further comprises a power component, and
the power component is configured to convert the transmission of the MS/TP packet into electrical power, such that the bridge device is powered by activity of the MS/TP communication bus.

18. The bridge device of claim 16, wherein:
the first MS/TP packet comprises at least one of MS/TP address information; Network Protocol Data Unit (NPDU) information; or Application Protocol Data Unit (APDU) information,
the processing circuit is configured to identify the at least one of MS/TP address information; NPDU information; or APDU information from the MS/TP packet, and
the first security configuration is based on the at least one of MS/TP information; NPDU information; or APDU information.

19. The bridge device of claim 16, wherein:
the MS/TP packet comprises a Building Automation Control network (BACnet) BACnet request,
the processing circuit is further configured to identify a BACnet service type from the BACnet request, and
the security configuration is based on the BACnet service type.

20. The bridge device of claim 16, wherein:
the processing circuit is further configured to automatically provide to the first MS/TP network segment a second MS/TP packet responsive to the first MS/TP packet not being selectively forwarded to the second MS/TP network segment BACnet device based on the security configuration, and
the second MS/TP packet comprises:
a rejection response; and
information to proxy a BACnet device coupled to the second MS/TP network segment device as a provider of the second MS/TP packet.
